(19) United States
(12) Patent Application Publication
(10) Pub. No.: US 2018/0087762 A1
(43) Pub. Date: Mar. 29, 2018

(54) LIGHTING DEVICE WITH IMPROVED THERMAL PERFORMANCE SPEC

(71) Applicant: PHILIPS LIGHTING HOLDING B.V., EINDHOVEN (NL)

(72) Inventors: Peter Johannes Martinus BUKKEMS, EINDHOVEN (NL); Aldegonda Lucia WEIJERS, EINDHOVEN (NL); Simon Eme KADIJK, EINDHOVEN (NL)

(21) Appl. No.: 15/563,580

(22) PCT Filed: Mar. 17, 2016
(86) PCT No.: PCT/EP2016/055841

§ 371 Date: Sep. 30, 2017

(30) Foreign Application Priority Data
Mar. 30, 2015 (EP) 15161608.3

(51) Int. Cl. F21V 29/70; F21K 9/232; F21K 9/66; F21V 29/506; F21V 23/00; F21V 29/87

(52) U.S. Cl. CPC F21V 29/70; F21K 9/232; F21K 9/66; F21Y 2103/30; F21V 23/006; F21V 29/87; F21V 29/506

(57) ABSTRACT

A lighting device (100, 400) comprising a cover having an inside (128) and an outside (129). The cover defines a light emitting portion (112), a driver circuitry chamber (114), a transition portion (113) between the light emitting portion (112) and the driver circuitry chamber (114), and a cap portion (115) at the opposite end of the driver circuitry chamber (114) compared to the transition portion (113). The lighting device (100, 400) further comprises a carrier (104) arranged in the light emitting portion (112) and solid state light sources (106) mounted on the carrier (106). The lighting device (100, 400) further comprises a thermally conductive inlay (120, 121, 420, 421) in thermal contact with the cover and arranged along the inside of the cover for transferring heat from the light emitting portion (112) to at least one of the transition portion (113), the driver circuitry chamber (114) and the cap portion (115).

### FIELD OF THE INVENTION

The present invention relates to a lighting device.

### BACKGROUND

LED (light emitting diode) lamps are designed as retrofits for current lighting devices, such as incandescent bulbs and tube lighting. The LEDs generate heat during operation due to the imperfect conversion from electrical energy to light. The heat will raise the temperature of the LEDs. As there is a limit to how much heat and temperature an LED can handle before breaking down or severely shortening the lifetime of the LED, there is also a need to handle the heat generated. There are some known solutions to the heat and temperature problem, these may be for example heat spreaders, cooling fins i.e. forms of external cooling structures which are in contact with the ambient environment to transport the heat away from the lamp. However, such additions therefore lead to a lamp comprising a large number of components with inherent disadvantages such as costs for complex components and additional handling during assembly.

WO 2014/087366 discloses a lighting device comprising a light emitting portion with at least two solid state light sources, SSL. The light emitting portion includes a first cover member with a first light source carrier and a first light transmitting portion, a second cover member with a second light source carrier and a second light transmitting portion. The first and second cover member are arranged such that a first light transmitting portion is aligned with the second SSL to allow transmission of light emitted from the second SSL through the first cover member, and a second light transmitting portion is aligned with the first SSL to allow transmission of light emitted from the first SSL through the second cover member. According to this design, light emitted from an SSL on one cover member will be transmitted through the other cover member. Spreading of heat from each SSL may be provided in the other direction, i.e. in a direction opposite to the light emitting direction of each SSL, after which the heat is transferred to the ambient environment through the cover member.

### SUMMARY

It is an object of the present invention to provide a lighting device with improved thermal performance.

According to an aspect of the invention, these and other objectives are achieved by a lighting device which comprises a cover having an inside and an outside. The cover defines a light emitting portion, a driver circuitry chamber, a transition portion between the light emitting portion and the driver circuitry chamber, and a cap portion at the opposite end of the driver circuitry chamber compared to the transition portion. The lighting device further comprises a carrier arranged in the light emitting portion and solid state light sources mounted on the carrier. The lighting device further comprises a thermally conductive inlay in thermal contact with the cover and arranged along the inside of the cover for transferring heat from the light emitting portion to at least one of the transition portion, the driver circuitry chamber and the cap portion.

The present invention is based on the realization that the thermal performance of the lighting device may be improved by the addition of a thermally conductive inlay in thermal contact with the cover and arranged along the inside of the cover for transferring heat from the light emitting portion to at least one of the transition portion, the driver circuitry chamber and the cap portion. Improved thermal performance means that the maximum temperature under steady-state operating conditions is lower, which is realized by an improved heat spreading over the lighting device, hence the temperature distribution over the lighting device during operation is at least partly more uniform along e.g. the longitudinal axis of the lighting device. Experiments have shown that the temperature of the light emitting portion during operation of the lighting device may decrease due to the inlay, whereas the temperature of e.g. the driver circuitry chamber is increased. The thermally conductive inlay conducts heat from the light emitting portion to at least one of the transition portion, the driver circuitry chamber and the cap portion and thereby enables a larger portion of the cover of the lighting device to act as an efficient heat transfer area with the ambient environment. Thus, the heat generated from the solid state light sources is also transported to at least one of the transition portion, the driver circuitry chamber and the cap portion through conduction by the thermally conductive inlay, and a larger portion of the outside of the cover is used to dissipate heat to the ambient environment. Hence, the present invention provides a lighting device with an improved thermal performance which in turn may prolong the lifetime of the solid state light sources. Another advantage is that the amount of light which can be emitted from the lighting device can be increased as the solid state light sources provided can be of a higher power rating, or driven at a higher power without generating heat and temperatures high enough to damage the solid state light sources. Another advantage is that external hotspots can be avoided or reduced, which may be useful in case a user happens to touch the lighting device when it is turned on.

In one embodiment of the invention, the inside of the cover at the transition portion may be sloped and/or perpendicular compared to a longitudinal axis of the lighting device, and the thermally conductive inlay may extend in conformity with the inside of the cover from the light emitting portion and into the transition portion. Hence, the thermally conductive inlay may extend in conformity with the inside of the cover only along the light emitting portion and transition portion and not along the driver circuitry chamber and cap portion. Thereby, the thermally conductive inlay conducts heat from the light emitting portion to the transition portion, and heat may also be dissipated to the ambient environment through the inside of the cover to the outside of the cover at the transition portion. A larger surface area of the cover is thus provided to dissipate heat to the ambient environment.

In another embodiment of the invention, the thermally conductive inlay may extend in conformity with the inside of the cover from the light emitting portion, via the transition portion, and into the driver circuitry chamber. Hence, the thermally conductive inlay may longitudinally extend in conformity with the inside of the cover from the light emitting portion, via the transition portion, and into the driver circuitry chamber but not extend into the cap portion. The thermally conductive inlay may longitudinally extend for a portion of the driver circuitry chamber or through the complete driver circuitry chamber. Hence, the thermally conductive inlay conducts heat from the light emitting portion to the transition portion and the driver circuitry chamber, and heat may also be dissipated to the ambient environment through the inside of the cover to the outside of the cover at the transition portion and the driver circuitry chamber. An even larger surface area of the cover is thus provided to dissipate heat to the ambient environment.

The thermally conductive inlay may have a first section matching a portion of the inside of the light emitting portion of the cover, a second section which is sloped and/or perpendicular compared to the longitudinal axis of the lighting device to match (partly or completely) the inside of the transition portion of the cover, and a third section which may be curved around the longitudinal axis of the lighting device to match (partly or completely) the inside of the driver circuitry chamber of the cover. In other words, the thermally conductive inlay may comprise a first, second and third section each shaped in order to match the contour or profile of the inside of the cover. Thereby, an improved thermal contact can be provided between the thermally conductive inlay and the cover.

In one embodiment of the invention, the thermally conductive inlay may extend in conformity with the inside of the cover from the light emitting portion, via the transition portion and the driver circuitry chamber, and into the cap portion. The thermally conductive inlay may longitudinally extend for a portion of the cap portion or through the complete cap portion. Further, the thermally conductive inlay may have a fourth section which may be curved around the longitudinal axis of the lighting device to match (partly or completely) the inside of the cap portion of the cover. By extending the thermally conductive inlay along the inside of the cover along the light emitting portion, the transition portion, the driver circuitry chamber and the cap portion a yet even larger surface area of the cover may thus be provided to dissipate heat to the ambient environment. The fourth section which may be curved may allow the thermally conductive inlay to provide thermal contact over a larger portion of the cap portion. As an alternative, the third section of the thermally conductive inlay may be narrower, i.e. not as wide as the first, second and fourth section of the thermally conductive inlay in order to reduce the thermal contact in the driver circuitry chamber. The third section may be narrower by forming the thermally conductive inlay with a narrower third section or through local folding of the thermally conductive inlay. To provide sufficient heat conduction along the third section, i.e. from the light emitting portion to the cap portion via the third section, the third section may be thicker, e.g. by the aforementioned local folding or by forming the thermally conductive inlay with a thicker third section.

The shape of the inside of the cover may substantially correspond to the shape of the outside of the cover. The cover may for example have a substantially uniform thickness. In this way, the inlay may remain close to the outside of the cover.

The cover may comprise a first cover member, a second cover member, and a longitudinal joint between the first cover member and the second cover member. A cover comprising two parts along a longitudinal joint enables a simpler and more efficient assembly of the lighting device as the internal components may be fitted into the cover prior to bringing the first and second cover member together and sealing the joint. The joint may be sealed by any suitable means such as snap fitting, thermal weld, ultrasonic weld etc. Is should also be noted that the joint may be sealed by fixating the first and second cover member to each other via internal support structures on the inside of the cover members which may provide the aforementioned suitable means such as snap fitting, thermal weld, ultrasonic weld etc.

The thermally conductive inlay may be a first thermally conductive inlay which extends along the inside of the first cover member, and a second thermally conductive inlay may extend along the inside of the second cover member. Providing a thermally conductive inlay for each cover member may improve the thermal conduction and heat dissipation from each cover member. In order to save costs for manufacturing the lighting device it is of course also possible to provide a thermally conductive for only one of the cover members, e.g. a first thermally conductive inlay extending along the inside of the first cover member or a second thermally conductive inlay extending along the inside of the second cover member.

In one embodiment of the invention, the carrier may be arranged between the first thermally conductive inlay and the second thermally conductive inlay. In other words, the carrier is sandwiched between the first and second thermally conductive inlay. Thereby, both the first and second thermally conductive inlay may conduct heat from the light emitting portion of the cover to at least one of the transition portion, the driver circuitry chamber and the cap portion.

In another embodiment of the invention, the carrier may be arranged between first cover member and first inlay, and a second carrier with light sources directed in the opposite direction compared to the first light sources is arranged between the second inlay and the second cover member. By using an additional carrier, the first and second thermally conductive inlays may be seen as sandwiched between the carrier and the additional carrier. It should of course be noted that it is possible to provide only a first or the second thermally conductive inlay which is sandwiched between the carrier and the additional carrier.

The carrier may be arranged parallel to a plane defined by the joint between the first and second cover members. The plane may be flat. In some embodiments of the invention the plane may be partly twisted. A partly twisted plane means that the carrier forms a spiral surface. The spiral surface of the carrier may enable an improved distribution of light from the lighting device.

In one embodiment of the invention, the light sources may be arranged along a curved perimeter of the carrier, and the light emitting portion may have central area surrounded by a hollow ridge, which hollow ridge extends along the curved perimeter of the carrier and defines an optical chamber for the light sources. Here, the aforementioned first section of the inlay may match the central area, in order for the inlay not to block light emitted by the light sources.

In another embodiment of the invention, the light sources may be arranged at a central area of the carrier, and the light emitting portion has peripheral area surrounding a central optical chamber for the light sources. Here, the aforementioned first section of the inlay may match the peripheral area of the light emitting portion of the cover.

The thermally conductive inlay may be molded into the cover. Thereby, no separate step is required for fitting the thermally conductive inlay during assembly. Further, there is a reduced risk for any gap to form between the cover and the thermally conductive inlay due to an inexact fit which would provide a reduced thermal contact.

The thermally conductive inlay may be provided as a separate pre-shaped sheet. A separate pre-shaped sheet may be provided by press fitting a separate sheet in a mould to a desired shape.

The thermally conductive inlay may be formed by a material having thermal conductivity of at least 30 W/mK. A relatively large thermal conductivity of at least 30 W/mK enables the thermally conductive inlay to efficiently conduct heat.

The thermally conductive inlay may be equal to or less than 2 mm thick and preferably equal to or less than 0.5 mm thick.

The material forming the thermally conductive inlay may be chosen from the group of graphite compressed flakes, pyrolytic graphite, copper, copper alloys, aluminum, aluminum alloys, magnesium, zinc, iron, steel, aluminum-oxides and thermally conductive plastics with high graphite content. The above mentioned materials have high thermal conductivity and enable the thermally conductive inlay to transport heat from one portion of the cover to another.

In various embodiments of the invention, the thermally conductive inlay may extend along the inside of the cover at least 50% into the light emitting portion as seen in the direction of the longitudinal axis. The thermally conductive inlay may extend for at least 25% of the inner circumference of at least one of the driver circuitry chamber and the cap portion as seen in the circumferential direction about the longitudinal axis of the lighting device. According to another embodiment of the invention, the carrier may be formed by a dielectric layer on the thermally conductive inlay and electrically conducting tracks on the thermally conductive inlay.

According to another embodiment of the invention, the cover may be configured to diffuse the light emitted by the solid state light sources. The diffusion, e.g. scattering, of the light from the solid state light sources will provide a more aesthetically pleasing appearance of the lighting device as the solid state light sources do not appear as point sources of light to an observer. Further, the uniformity of the light emitted from the lighting device may be improved by diffusion of the light being transmitted through the cover.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

This and other aspects of the present invention will now be described in more detail, with reference to the appended drawings showing different embodiments of the invention.

FIG. 1A is an exploded perspective view of a lighting device according to one embodiment of the invention;

FIG. 1B is a side view of a cover member of the lighting device shown in FIG. 1A;

FIG. 2 is a perspective view of a thermally conductive inlay according to another embodiment of the invention;

FIG. 3A-D are perspective views of a cover member and a thermally conductive inlay according to various embodiments of the invention;

FIG. 4A is an exploded perspective view of a lighting device according to another embodiment of the invention;

FIG. 4B is a perspective cross section view of the lighting device shown in FIG. 4A; and

FIG. 5 is an exploded perspective view of a lighting device according to another embodiment of the invention.

### DETAILED DESCRIPTION OF THE DRAWINGS

In the present detailed description, embodiments of a lighting device according to the present invention are mainly discussed with reference to views showing the lighting device as a flat replacement bulb. It should be noted that this by no means limit the scope of the invention, which is also applicable in other circumstances for instance with other types of lighting devices shaped differently than the embodiments shown in the appended drawings. Like reference numerals refer to like elements throughout.

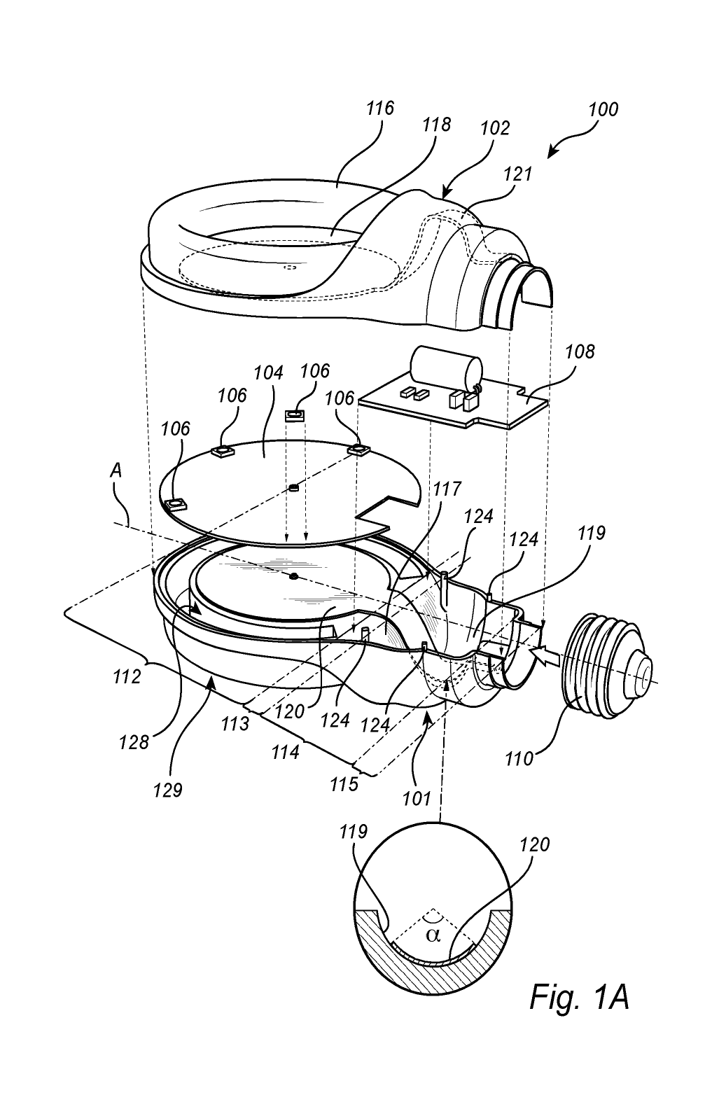

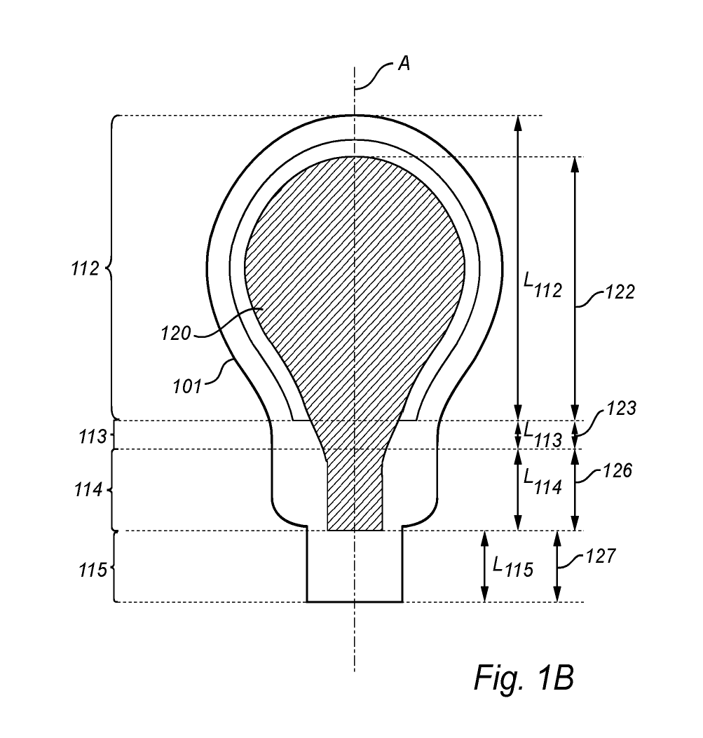

The invention will now be described with reference to the enclosed drawings where first attention will be drawn to the structure, and then secondly the function. FIG. 1A shows an exploded perspective view of a lighting device 100 according to one embodiment of the invention. The lighting device 100 has a shape and design imitating the traditional incandescent bulb with a flattened bulb portion. The lighting device 100 comprises a cover having an inside 128 and an outside 129. The cover is formed by a first cover member 101 and a second cover member 102. The cover has, in succession, a light emitting portion 112, a transition portion 113, a driver circuitry chamber 114 and a cap portion 115. The transition portion 113 is arranged between the light emitting portion 112 and the driver circuitry chamber 114. The cap portion 115 is arranged at the opposite end of the driver circuitry chamber 114 compared to the transition portion 113. The first cover member 101 and second cover member 102 are preferably geometrically identical in order to e.g. facilitate manufacturing and joining of the two cover members. In the embodiment shown in FIG. 1A the light emitting portion 112 of the cover members 101, 102 comprises a hollow ridge 116, or a groove as seen from the inside, and a central area 118 which is flat and surrounded by the hollow ridge 116. The inside of the first cover member 101 and the second cover member 102 at the transition portion 113 is sloped, indicated by the sloped portion 117, compared to the longitudinal axis A of the lighting device. The driver circuitry chamber 114 has a circumferential portion 119 around the longitudinal axis A of the lighting device 100. As can be seen in FIG. 1A the shape of the inside of the cover substantially corresponds to the shape of the outside of the cover, thus the cover may have a substantially uniform thickness.

The first and second cover members 101, 102 are preferably diffusively transparent or translucent to allow light emitted from solid state light sources 106 within the shaped cover to pass through to the outside of the shaped cover. The diffuse effect will provide a more desirable appearance and effect such that the solid state light sources 106 are not observed as point sources of light. The first and second cover members 101, 102 may also have other optical functions, such as beam shaping etc. The first and second cover members 101, 102 are secured to each other for example along the longitudinal joint by any suitable means such as snap fitting, glue, a thermal weld or the like. The first and second cover members 101, 102 may also be secured to each other by internal support or attachment structures shown as pins 124 on the inside of the first and second cover members 101, 102. Is should of course be noted that the pins 124 may be used for guiding the first and second cover members 101, 102 together during assembly and the longitudinal joint between the first and second cover members 101, 102 is then sealed by the aforementioned means.

The lighting device 100 comprises a carrier 104 arranged in the light emitting portion 112 of the cover. The carrier is arranged parallel to the longitudinal axis A of the lighting device 100. The carrier 104 in FIG. 1A supports the solid state light sources 106. The solid state light sources 106 are mounted on the carrier 104, preferably using conventional techniques, like surface-mount technology (SMT). A main or central light emitting direction of the light souces is perpendicular to the carrier 104. The carrier 104 can comprise electrical connections for the solid state light sources 106. The carrier may for example be a printed circuit board (PCB) of any kind, with electrically conductive tracks or segments. The carrier 104 is arranged parallel to the flat plane defined by the longitudinal joint of the cover between the first cover member 101 and the second cover member 102. The carrier 104 is preferably arranged in a fixed relationship relative to the lighting device 100.

The solid state light sources 106 are mounted on the carrier 104 facing the cover, and connected to the electrically conductive tracks or segments (not shown) of the carrier 104. Note that the solid state light sources 106 are usually arranged on both sides of the carrier 104, i.e. facing both the first cover member 101 and the second cover member 102. Further, the solid state light sources 106 are arranged to emit light in directions away from the carrier 104 through the light emitting portion of the cover 112 and in particular through the hollow ridge 116. The solid state light sources 106 are therefore arranged on the outer circumference of the carrier 104, along a curved perimeter of the carrier 104 next to the flat area 118 of the first and second cover members 101, 102. The hollow ridge 118 thus defines an optical chamber for the light sources 106. Hence, the solid state light sources 106 are arranged to match the hollow ridge 116. The solid state light sources 106 may be any kind of solid state light sources, such as light emitting diodes (LED), OLEDs, PLEDs or the like. LEDs should be broadly interpreted as LED dies, LED subassemblies or packaged LEDs.

The lighting device 100 further comprises driver circuitry 108 arranged within the driver circuitry chamber 114. In general, the driver circuitry 108 should be understood to be circuitry capable of converting electricity from mains to electricity suitable to drive the solid state light sources 106. Therefore, the driver circuitry 108 is typically capable of at least converting AC to DC and to a suitable voltage for driving the solid state light sources 106.

The lighting device 100 further comprises a base 110 for electrical and mechanical connection to lamp socket (not shown). The base 110 may be arranged around the outside of the cap portion 115 of the cover. The base 110 is connected to driver circuitry 108 in order to supply electrical power from mains to the driver circuitry 110. The base 110 may also be referred to as a fitting or end cap. Here, the base 110 is a single base. The base 110 may for example, and as shown, be a screw base having an external thread e.g. Edison screw base. However, the present lighting device could also have a different lamp base, such a bayonet or bi-pin etc.

The lighting device 100 further comprises a first thermally conductive inlay 120 in thermal contact with the cover, here shown in thermal contact with the first cover member 101, and a second thermally conductive inlay 121 arranged in thermal contact with the second cover member 102. Henceforth, details of the first thermally conductive inlay 120 will be described, the same details and description of course also applies to the second thermally conductive inlay 121. Thermal contact herein generally refers to thermal conduction. Thermal contact between the first thermally conductive inlay 120 and the first cover member 101 can thus be effected by three possible scenarios. The first scenario is that the two solid bodies are in physical contact, i.e. the first cover member 101 and the first thermally conductive inlay 120 are arranged in direct physical contact. The second scenario is that the two solid bodies are arranged in indirect physical contact with an intermediate thin layer of a thermal interface material in between. The thermal interface material may for example be glue or another type of material arranged between the first cover member 101 and the first thermally conductive inlay 120 e.g. in order to fasten the two materials to each other. The third scenario is that the first cover member 101 and the first thermally conductive inlay 120 are arranged with a thin air gap between them. The air gap should be thinner than approximately 0.2 mm in order to provide substantial thermal conduction instead of a thermal insulating effect forming a considerable thermal barrier. The first thermally conductive inlay 120 is arranged and extends in conformity with the inside of the first cover member 101 from the light emitting portion 112 and into the driver circuitry chamber 114 via the transition portion 113 for transferring heat from the light emitting portion 112 along the longitudinal axis A of the lighting device 100 and thereby provide an improved thermal performance.

Note that the inside of the first cover member 101 at the transition portion 113 comprises the sloped portion 117 which is sloped compared to the longitudinal axis A of the lighting device 100. The first thermally conductive inlay 120 extends in conformity with the inside of the first cover member 101 from the light emitting portion 112, to the driver circuitry chamber 114 via the transition portion 113. The first thermally conductive 120 inlay therefore has a three-dimensional shape in order to follow the inner contour of the first cover member 101 and thereby stay in thermal contact along the longitudinal extension with the first cover member 101.

FIG. 1B shows a side view of the first cover member 101 and the first thermally conductive inlay 120 of the lighting device 100. The lengthwise extension of the first thermally conductive inlay 120 to the light emitting portion 112 is indicated in FIG. 1B by the arrow 122 showing the extension of the first thermally conductive inlay 120 in relation to the length of the light emitting portion L₁₁₂. The first shaped thermally conductive inlay 120 extends along the inside of the first cover member 101 for a lengthwise extension, i.e. as seen in the direction of the longitudinal axis, of at least 50% of the length of the light emitting portion L₁₁₂. However, as indicated and shown by arrow 122 in FIG. 1B the shaped thermally conductive inlay can also extend for a larger portion the length of the light emitting portion L₁₁₂, such as 55%, 65%, 75%, 85%, 95%, any number in between or more. Further, and as described above the first thermally conductive inlay 120 extends from the light emitting portion 112, via the transition portion 113, to the driver circuitry chamber 114 seen along the longitudinal axis A. The extension of the first thermally conductive inlay 120 along the length of the transition portion L₁₁₃ is indicated by the arrow 123. As the first thermally conductive inlay 120 extends further to the driver circuitry chamber 114 herein, the full length of the transition portion is covered. The extension of the first thermally conductive inlay 120 along the length of the driver circuitry chamber L₁₁₄ is indicated by the arrow 126. In the embodiment shown in FIGS. 1A and 1B the first thermally conductive inlay 120 extends the complete driver circuitry chamber 114. However, the first thermally conductive inlay 120 may instead extend for a smaller portion of the length of the driver circuitry chamber L₁₁₄, such as 5%, 15%, 25%, 35%, 45%, 55%, 65%, 75%, 85%, 95%, any number in between. The extension of the first thermally conductive inlay 120 along the length of the cap portion L₁₁₅ is indicated by the arrow 127. In the embodiment shown in FIGS. 1A and 1B the first thermally conductive inlay 120 only extends in conformity with the inside of the cover over the driver circuitry chamber 114 via the transition portion 113. However, in other embodiments the first thermally conductive inlay 120 may also extend for a portion of the length of the cap portion L₁₁₅, such as 5%, 15%, 25%, 35%, 45%, 55%, 65%, 75%, 85%, 95%, any number in between.

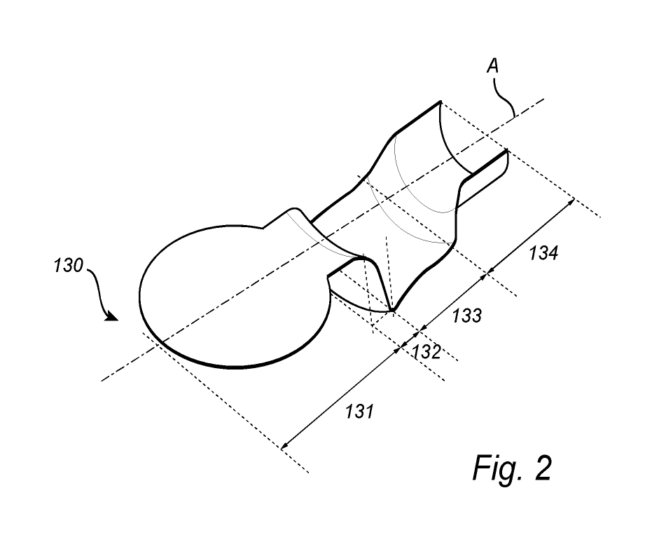

FIG. 2 shows a thermally conductive inlay 130 according to an embodiment of the invention. The thermally conductive inlay 130 has a first section 131 matching a portion of the inside of the light emitting portion 112 of the cover, namely the central area 118 which is flat. The thermally conductive inlay 130 has a second section 132 which is sloped and/or perpendicular compared to the longitudinal axis A of the lighting device 100 to match the inside of the transition portion 113 of the cover. The thermally conductive inlay 120 further has a third section 133 to match the inside of the driver circuitry chamber 114 of the cover. The third section may thus be curved around the longitudinal axis A of the lighting device 100 as described below in order to cover a portion of the inner circumference of the driver circuitry chamber 114. The thermally conductive inlay 130 also has a fourth section 134 which extends from the third section and is intended to provide thermal contact with the cap portion 115. Thus, the fourth section may also be curved around the longitudinal axis A of the lighting device 100 to match the inside of the cap portion 115. In other words, the thermally conductive inlay may comprise a first, second, third and fourth section each shaped in order to match the contour or profile of at least some of the inside of the cover. Thereby, an improved thermal contact can be provided between the thermally conductive inlay and the portion of the cover.

Returning to FIG. 1A, each of the first thermally conductive inlay 120 and second thermally conductive inlay 121 may extend for at least 25% of the total inner circumference of the driver circuitry chamber 114, as seen in the circumferential direction. In other words, the arc length of the inlay 120 (or 121) may be at least 25% of the circumference of the driver circuitry chamber 114. Shown in FIG. 1A is the circumferential portion 119, and the coverage of the first thermally conductive inlay 120 is indicated by the angle α in FIG. 1A. For 25%, the angle α corresponds to at least 90 degrees. The first and/or second thermally conductive inlays 120, 121 may also cover a smaller or larger portion of the circumferential portion 119, whereby the angle α for example may be 45-90 deg or 90-180 deg, respectively. It should of course be noted that the circumferential portion 119 could have another shape, such as square, rectangular, polygonal or the like. Each of the first and second thermally conductive inlays 120, 121 would then for example cover an area equal to or larger than 25% of the inner circumference of such a shape.

The first shaped thermally conductive inlay 120 of FIG. 1A and FIG. 1B can then alternatively be described as having longitudinal axis and comprising a first section having a flat portion corresponding to the central flat area 118, a second section which is sloped to form a sloped second section. The first thermally conductive inlay 120 then further comprises a third section extending substantially in a direction along the longitudinal axis A and which is curved about the longitudinal axis A in order to match the inner circumferential portion 119 of the driver circuitry chamber 114. The first section is substantially planar, and extends along the longitudinal axis A. The second section can be understood to form a slope extending from the flat portion. The second section may be either essentially straight or arced to form the slope.

The thermally conductive inlays shown in the appended drawings is formed by a separate sheet having a substantially equal thickness less than 2 mm, and preferably equal to or less than 0.5 mm thick. Further, the first thermally conductive inlay 120 is formed by a material having thermal conductivity of at least 30 W/mK. As a comparison, plastics used to form the cover usually have a thermal conductivity less than 1 W/mK. The separate sheet forming the thermally conductive inlay 120 is e.g. press fitted, prior to any steps of assembly, into a mould in order to form to the desired shape. The first thermally conductive inlay 120 is preferably formed by a material chosen from the group of graphite compressed flakes, pyrolytic graphite, copper, copper alloys, aluminum, aluminum alloys, magnesium, zinc, iron, steel, aluminum-oxides and thermally conductive plastics with high graphite content. Other types of materials could also be used to form the shaped thermally conductive inlay 120 but may have drawbacks relating to e.g. costs such as gold, silver, nickel, tungsten, molybdenum, diamond, AlN, BN, SiC etc.

An alternative not illustrated in the appended drawings it to provide the first thermally conductive inlay 120 molded into the first cover member 101. By molding the first thermally conductive inlay 120 into the cover, a desired shape and thermal contact is guaranteed. Either or both of the first and second thermally conductive inlays 120, 121 may be molded into the first cover member 101 or the second cover member 102.

Note that the carrier 104 with the solid state light sources 106 is arranged between the first thermally conductive inlay 120 and the second thermally conductive inlay 121 when the lighting device 100 is assembled. The carrier 104 is thus sandwiched as an intermediate material between the first thermally conductive inlay 120 and the second thermally conductive inlay 121 which allows the first thermally conductive inlay 120 to transfer heat to the first cover member 101 and the second thermally conductive inlay 121 to transfer heat to the second cover member 102.

In use, the lighting device 100 is electrically and mechanically connected to a lamp socket (not shown) and is supplied mains electricity to the driver circuitry 108 via the base 110. The driver circuitry 108 converts the electricity to a voltage and power suitable for driving the light sources 106, e.g. DC instead of the AC in the mains and a lower voltage than the typical 100-220V found in mains. The driver circuitry 108 supplies power to the electrically conductive tracks or segments (not shown) of carrier 104 and to the light sources 106, which thereby emit light. Due to the imperfect conversion from electricity to light, heat is generated by the solid state light sources 106. Heat is transferred to the shaped cover in the vicinity of the solid state light sources 106, i.e. such as the central flat area 118 and the cover dissipates the heat to the ambient environment. However, heat is also conducted by the first thermally conductive inlay 120 along the longitudinal axis A of the lighting device 100 to the driver circuitry chamber 114 via the transition portion 113. Thereby, the transition portion 113 and the driver circuitry chamber 114 of the cover also dissipates heat to the ambient environment and provides an improved thermal performance of the lighting device 100, which also has a more even temperature along the longitudinal axis A.

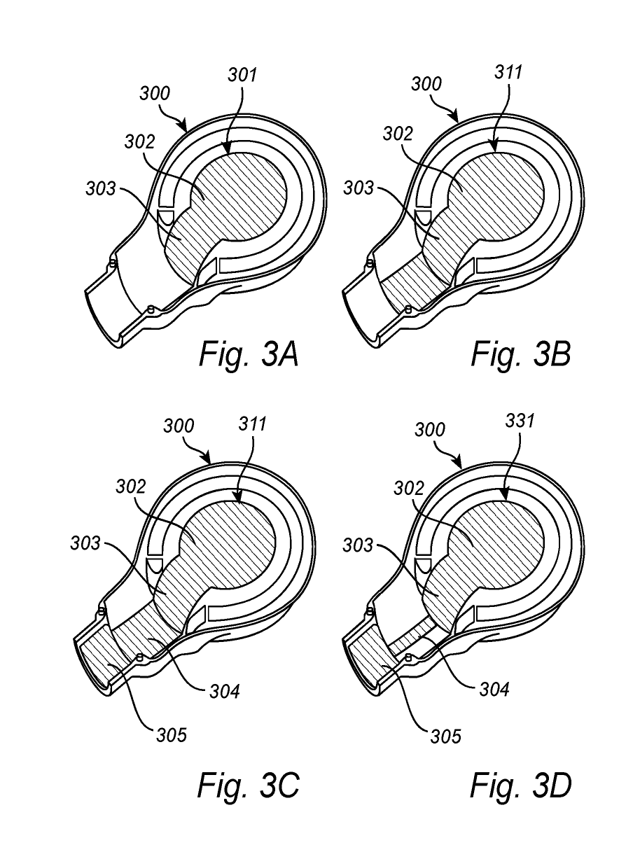

FIGS. 3A-3D shows cover members and thermally conductive inlays for a lighting device according to various embodiments of the invention. Note that the cover members shown in FIGS. 3A-3D have the same details and features and substantially correspond to the first cover member 101 shown in FIG. 1. FIG. 3A shows a thermally conductive inlay 301 arranged in a cover member 300. The thermally conductive inlay 301 extends in conformity with the inside of the cover member 300 from the light emitting portion to the transition portion. Note that the thermally conductive inlay 301 follows the profile of the inside of the cover member 300 even at the transition portion which is sloped. The thermally conductive inlay 301 may be described as having a first section 302 which matches part of the inside of the light emitting portion of the cover, and a second section 303 which is sloped and/or perpendicular compared to the longitudinal axis of the lighting device to match the inside of the transition portion of the cover. The thermally conductive inlay 301 is thus in thermal contact with both the light emitting portion and the transition portion and heat can be conducted from the light emitting portion to the transition portion.

FIG. 3B shows an embodiment of a thermally conductive inlay 311 similar to the thermally conductive inlays 120,121 shown in FIGS. 1A and 1B. The thermally conductive inlay 311 extends in conformity with the inside of the cover from the light emitting portion, via the transition portion, to the driver circuitry chamber. The thermally conductive inlay 311 may be described as having a first section 302 which matches the inside of the light emitting portion of the cover, and a second section 303 which is sloped and/or perpendicular compared to the longitudinal axis of the lighting device to match the inside of the transition portion of the cover, and a third section 304 which is curved to match the inside of the driver circuitry chamber of the cover. Hence, heat can be conducted through the thermally conductive inlay 311 from the light emitting portion to the driver circuitry chamber.

FIG. 3C shows an embodiment of a thermally conductive inlay 321 with the same features as the thermally conductive inlay of FIG. 3B. However, the thermally conductive inlay 321 shown in FIG. 3C further comprises a fourth section 305 and extends into the cap portion thereby enabling conduction of heat into the cap portion. The fourth section 305 is curved in order to conform to the inside of the cap portion and provide an improved thermal contact. The fourth section thus allows the thermally conductive inlay 321 to conduct heat also to the cap portion.

FIG. 3D shows an alternative embodiment of the inlay shown in FIG. 3C where the third section 314 of the thermally conductive inlay 331 is narrower than the other sections. The thermal contact with the driver circuitry chamber is thus reduced, which may allow the driver circuitry to heat the driver circuitry chamber to a larger extent. The third section 314 may be narrower by forming the thermally conductive inlay 331 with a narrower third section 314 or through local folding of the thermally conductive inlay 331. To provide sufficient heat conduction along the third section 331, i.e. from the light emitting portion to the cap portion via the third section 314, the third section 314 may be thicker, e.g. by the aforementioned local folding or by forming the thermally conductive inlay 331 with a third section 314 formed by a thicker material.

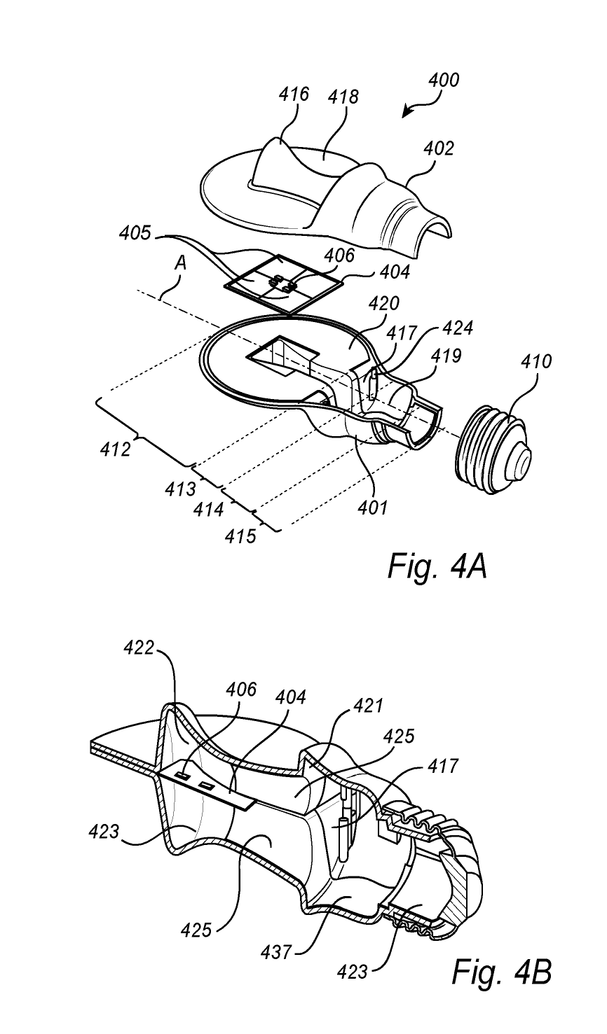

FIG. 4A shows an exploded perspective view of a lighting device 400 according to another embodiment of the invention. The lighting device 400 also has a shape and design imitating the traditional incandescent bulb with a flattened bulb portion. The lighting device 400 comprises a cover having an inside and an outside. The cover is formed by a first cover member 401 and a second cover member 402. The cover has, in succession, has a light emitting portion 412, a transition portion 413, a driver circuitry chamber 414 and a cap portion 415. The transition portion 413 is arranged between the light emitting portion 412 and the driver circuitry chamber 414. The cap portion 415 is arranged at the opposite end of the driver circuitry chamber 414 compared to the transition portion 413. The first cover member 401 and second cover member 402 are preferably geometrically identical in order to e.g. facilitate manufacturing and joining of the two cover members. The light emitting portion 412 of the first and second cover members 401, 402 comprises a central hollow ridge 416, or a groove as seen from the inside, and a peripheral area 418 which is flat and surrounds the hollow ridge 416. The inside of the first cover member 401 and the second cover member 402 at the transition portion 413 is sloped, shown by the sloped portion 417, compared to the longitudinal axis A of the lighting device. The driver circuitry chamber 414 has a circumferential portion 419 around the longitudinal axis A of the lighting device 400. As can be seen in FIG. 4B the shape of the inside of the cover substantially corresponds to the shape of the outside of the cover, through a substantially uniform thickness of the cover member 401, 402.

The first and second cover members 401, 402 are otherwise similar and may have the same features as the cover members described earlier such as being diffusively transparent, other optical functions, being secured to each other for example along the longitudinal joint by any suitable means. The lighting device 400 comprises a carrier 404 arranged in the light emitting portion 412 of the cover, parallel to the flat plane defined by the joint between the first cover member 401 and second cover member 402. The carrier 404 supports the solid state light sources 406. The carrier 404 and light sources 406 has the same features and alternatives as the carrier 104 and light sources 106 described earlier. However, a difference is that the carrier 404 further comprises a plurality of thermally conductive pads 405 arranged on the carrier. The thermally conductive pads 405 are made from a thermally conductive material such as a metal, preferably copper. Further, another difference is that the solid state light sources 406 are arranged at a central area of the carrier 404 and the hollow ridge 116 of each cover member 401, 402 forms a central optical chamber 422, 423 shown in FIG. 4B for the solid state light sources 406.

The lighting device 400 further comprises driver circuitry (not shown) arranged within the driver circuitry chamber 414.

The lighting device 400 further comprises a base 410 for electrical and mechanical connection to lamp socket (not shown). The base 410 may be arranged around the outside of the cap portion 415 of the cover. The base 410 is connected to driver circuitry (not shown) in order to supply electrical power from mains to the driver circuitry 410. The base 410 may also be referred to as a fitting or end cap. Here, the base 410 is a single base. The base 410 may for example, and as shown, be a screw base having an external thread e.g. Edison screw base. However, the present lighting device could also have a different lamp base, such a bayonet or bi-pin etc.

The lighting device 400 further comprises a first thermally conductive inlay 420 in thermal contact with the first cover member 401 and a second thermally conductive inlay 421, shown in FIG. 4B, arranged in thermal contact with the second cover member 402. For the sake of brevity, only the first thermally conductive inlay 420 will be described, the same features and description of course applies to the second thermally conductive inlay 421 as well. The first thermally conductive inlay 420 is arranged and extends along and in conformity with the inside of the first cover member 401 from the light emitting portion 412 and to the transition portion 113, the driver circuitry chamber 114 and the cap portion 115.

Thus, in the embodiment shown in FIGS. 4A and 4B the first thermally conductive inlay 420 extends throughout the lighting device 400. It should be noted that in other embodiments, not explicitly shown in the appended drawings, the first thermally conductive inlay 420 may extend for just along the light emitting portion 412 and the transition portion 413, or also along the driver circuitry chamber 414. The first thermally conductive inlay 420 may thus be similar to different embodiments shown in FIGS. 3A-3D. It is also possible that the first thermally conductive inlay 420 extends for a portion and not the complete driver circuitry chamber 414, or the cap portion 415.

Now referring to FIG. 4B, as the hollow ridge 416 of the cover connects to the driver circuitry chamber 414, the first thermally conductive inlay 420 may also partly cover an inside portion 425 of the hollow ridge 416. Thereby, the thermally conductive inlay 420 will be in thermal contact with a larger surface area of the cover which may then dissipate heat to the ambient environment. The first thermally conductive inlay 420 also has a curved section 427 in the driver circuitry chamber 414 in order to better conform to the inside of the cover. Likewise, the section 428 of the first thermally conductive inlay 420 which extends into the cap portion 415 also has a curved portion in order to conform to the inside of the cap portion 415.

In use, the lighting device 400 is electrically and mechanically connected to a lamp socket (not shown) and is supplied mains electricity to the driver circuitry (not shown). The driver circuitry supplies power to the carrier 404 and to the light sources 406, which thereby emit light into the central optical chambers 422, 423 which is then transmitted through the cover and provides lighting. Heat is then generated by the solid state light sources 406. Heat is transferred to the shaped cover in the vicinity of the solid state light sources 406, i.e. such as the peripheral area 118 and the cover dissipates the heat to the ambient environment. Heat transfer to the shaped cover and the first and/or second thermally conductive inlay 420,421 from the solid state light sources 406 is improved by the thermally conductive pads 405. Heat is also conducted by the first thermally conductive inlay 420 along the longitudinal axis A of the lighting device 400 to the driver circuitry chamber 414 via the transition portion 413 and to the cap portion 415. Thereby, the transition portion 413, the driver circuitry chamber 414 and the cap portion 415 of the cover also dissipates heat to the ambient environment and provides an improved thermal performance of the lighting device 400 which then has a more even temperature along the longitudinal axis A.

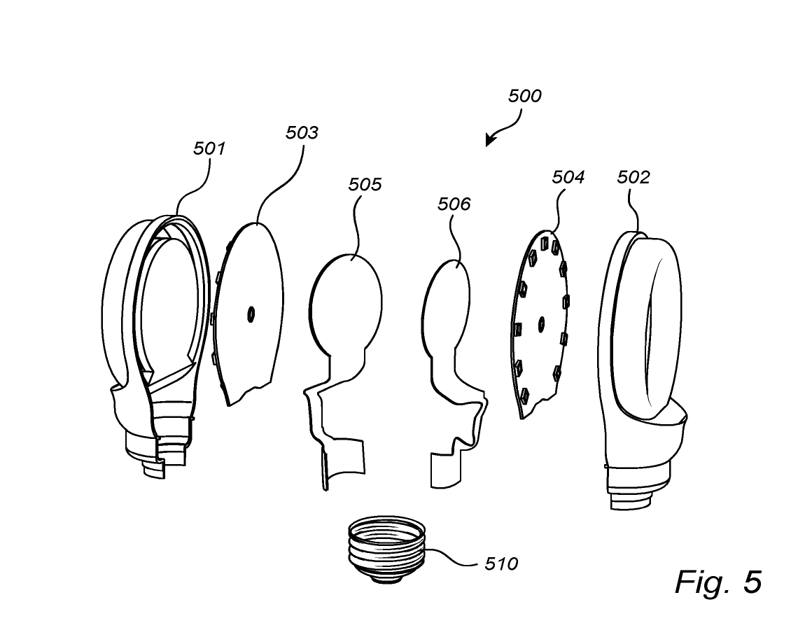

FIG. 5 shows an exploded perspective view of a lighting device 500 according to another embodiment of the invention. The lighting device 500 comprises a first cover member 501, a second cover member 502, a first carrier 503 and a second additional carrier 504. The first and second cover members 501, 502 are substantially similar to the cover members shown and described together with the embodiment shown in FIG. 1A. Likewise, the first and second carriers 503, 504 are substantially similar to the carrier described above in connection with FIG. 1A. The lighting device 500 further comprises a first thermally conductive inlay 505 and a second thermally conductive inlay 506. The lighting device 500 also comprises driver circuitry (not shown) arranged in the cover, and a base 510 for mechanical and electrical connection to a socket. The first carrier 503 has light sources mounted thereupon which are facing the first cover member 501, and the second carrier 504 has light source mounted thereupon which are facing the opposite direction, i.e. towards the second cover member 502.

The lighting device 500 shown in FIG. 5 is thus an alternative arrangement where the first carrier 503 is arranged between the first cover member 501 and the first thermally conductive inlay 505. Likewise, the second carrier 504 is arranged between the second cover member 502 and the second thermally conductive inlay 506. The first carrier 503 is sandwiched between the first cover member 501 and the first thermally conductive inlay 505. The first thermally conductive inlay 505 is thus in thermal contact with the first cover member 501 through the first carrier 503 which act as an intermediate thermal material. The same applies to the second thermally conductive inlay 506 which is in thermal contact with the second cover member 502 through the second carrier 504. Further, the first and second thermally conductive inlays 505, 506 are arranged in between the first and second carrier 503, 504 and are each able to conduct heat from the light emitting portion of the cover, through the first and second carrier 503, 504, along the longitudinal extent of the lighting device 500 to the transition portion, the driver circuitry chamber and the cap portion such that heat is transferred to other portions of the cover and a larger surface area is available to dissipate heat to the ambient environment. It should of course be noted that it is possible to provide only the first or the second thermally conductive inlay 505, 506 sandwiched between the first and second carriers 503, 504 and still conduct heat to other portions of the cover.

It should be noted that the effects of inventive concept are also reached by using just one thermally conductive inlay such as only the first shaped thermally conductive inlay 120, 420, 505 or only the second shaped thermally conductive inlay 121, 421, 506.

As an alternative (not shown) the carrier could also be formed by a dielectric layer and electrically conducting tracks formed directly on the shaped thermally conductive inlay 120.

Furthermore, the longitudinal joint between the cover members could also be curved thus leading to the plane being defined by the longitudinal joint between the first and second cover members being partly twisted. With a partly twisted plane, the carrier forms a spiral surface to fit in the lighting device. The spiral surface of the carrier means that the light sources will have non-parallel optical axises and thus the distribution of light from the lighting device can be improved. Furthermore, while lighting devices having a substantially circular or pear-shaped profile to mimic a “traditional” light bulb have been shown in the drawings, the lighting devices could alternatively have a candle-shaped profile, for example.

The lighting devices 100, 400, 500 may for example be used in lighting fixtures or luminaires for illumination purposes. The lighting devices 100, 400, 500 may be used as a replacement or retrofit bulbs in conventional lighting fixtures or luminaires.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination may not be used to an advantage.

1. A lighting device, comprising:
a cover having an inside and an outside, the cover defining a light emitting portion, a driver circuitry chamber, a transition portion between the light emitting portion and the driver circuitry chamber, and a cap portion at the opposite end of the driver circuitry chamber compared to the transition portion;
a carrier arranged in said light emitting portion; and
solid state light sources mounted on said carrier;
wherein the lighting device further comprises a thermally conductive inlay in thermal contact with the cover and arranged along the inside of the cover at least extending from the emitting portion into the transition portion for transferring heat from said light emitting portion to at least one of the transition portion, the driver circuitry chamber and the cap portion,
wherein the light sources are arranged along a curved perimeter of the carrier, and wherein the light emitting portion has central area surrounded by a hollow ridge, which hollow ridge extends along the curved perimeter of the carrier and defines an optical chamber for the light sources,
wherein the thermally conductive inlay has a first section matching a portion of the inside of the light emitting portion of the cover, a second section which is sloped and/or perpendicular compared to the longitudinal axis of the lighting device to match the inside of the transition portion of the cover, and a third section which is curved around the longitudinal axis of the lighting device to match the inside of the driver circuitry chamber of the cover.

2. A lighting device, comprising:
a cover having an inside and an outside, the cover defining a light emitting portion, a driver circuitry chamber, a transition portion between the light emitting portion and the driver circuitry chamber, and a cap portion at the opposite end of the driver circuitry chamber compared to the transition portion;
a carrier arranged in said light emitting portion; and
solid state light sources mounted on said carrier;
wherein the lighting device further comprises a thermally conductive inlay in thermal contact with the cover and arranged along the inside of the cover at least extending from the emitting portion into the transition portion for transferring heat from said light emitting portion to at least one of the transition portion, the driver circuitry chamber and the cap portion,
wherein the light emitting portion comprises a central hollow ridge and a peripheral area which is flat and surrounds the hollow ridge, the solid state light sources are arranged at a central area of the carrier and the hollow ridge forms a central optical chamber for the solid state light sources,
wherein the thermally conductive inlay has a first section matching a portion of the inside of the light emitting portion of the cover, a second section which is sloped and/or perpendicular compared to the longitudinal axis of the lighting device to match the inside of the transition portion of the cover, and a third section which is curved around the longitudinal axis of the lighting device to match the inside of the driver circuitry chamber of the cover.

3. A lighting device according to claim 1, wherein the inside of the cover at the transition portion is sloped and/or perpendicular compared to a longitudinal axis of the lighting device, and wherein the thermally conductive inlay extends in conformity with the inside of the cover from the light emitting portion and into the transition portion.

4. A lighting device according to claim 1, wherein the thermally conductive inlay extends in conformity with the inside of the cover from the light emitting portion, via the transition portion, and into the driver circuitry chamber.

5. (canceled)

6. A lighting device according to claim 1, wherein the thermally conductive inlay extends in conformity with the inside of the cover from the light emitting portion, via the transition portion and the driver circuitry chamber, and into the cap portion.

7. A lighting device according to claim 1, wherein the shape of the inside of the cover substantially corresponds to the shape of the outside of the cover.

8. The lighting device according to claim 1, wherein the cover comprises a first cover member, a second cover member, and a longitudinal joint between the first cover member and the second cover member.

9. The lighting device according to claim 8, wherein said thermally conductive inlay is a first thermally conductive inlay which extends along the inside of the first cover member, and wherein a second thermally conductive inlay extends along the inside of the second cover member.

10. The lighting device according to claim 9, wherein the carrier is arranged between the first thermally conductive inlay and the second thermally conductive inlay.

11. The lighting device according to claim 8, wherein the carrier is arranged parallel to a plane defined by said joint.

12. The lighting device according to claim 11, wherein said plane is flat.

13. The lighting device according to claim 1, wherein the thermally conductive inlay is molded into said cover.

14. The lighting device according to claim 1, wherein the thermally conductive inlay is provided as a separate pre-shaped sheet.

15. The lighting device according to claim 1 wherein the thermally conductive inlay is formed by a material having thermal conductivity of at least 30 W/mK.
